(19) United States
(12) Patent Application Publication
(10) Pub. No.: US 2009/0301074 A1
(43) Pub. Date: Dec. 10, 2009

(54) HYDRODYNAMIC ASSEMBLY WITH A RETARDER AND A HYDRODYNAMIC CLUTCH

(75) Inventor: Markus Kley, Ellwangen (DE)

Correspondence Address: BAKER & DANIELS LLP;111 E. WAYNE STREET, SUITE 800, FORT WAYNE, IN, 46802, US

(73) Assignee: Voith Turbo GmbH & Co. KG, Heidenheim (DE)

(21) Appl. No.: 11/908,327

(22) PCT Filed: Mar. 19, 2007
(86) PCT No.: PCT/EP2007/002405

§ 371 Date: Aug. 20, 2009

(30) Foreign Application Priority Data
Mar. 22, 2006 (DE) 10 2006 013 003.0

(51) Int. Cl. F16D 33/02

(52) U.S. Cl. 60/348

(57) ABSTRACT

The invention relates to a hydrodynamic assembly
with a hydrodynamic retarder comprising a rotor and a stator;
with a hydrodynamic clutch, comprising a primary wheel and a secondary wheel;
the rotor and the stator of the retarder as well as the primary wheel and the secondary wheel of the clutch respectively form with each other a torus-shaped working chamber;
the rotor of the retarder and the secondary wheel of the clutch are joined to each other in torsion-proof manner, in axial direction in series in a back to back arrangement;
the primary wheel has a drive connection to a first input shaft;
the rotor and the secondary wheel have a drive connection to a second input shaft;

The inventive hydrodynamic assembly is characterized in that
the rotor and the secondary wheel can be moved jointly in axial direction between a first position, in which the secondary wheel is opposite the primary wheel at a minimum axial distance and the rotor is opposite the stator at a maximum axial distance, and a second position, in which the secondary wheel is opposite the primary wheel at a maximum distance and the rotor is opposite the stator at a minimum axial distance.

The invention relates to a hydrodynamic assembly which comprises a hydrodynamic retarder and a hydrodynamic clutch. Such an assembly is for example used in a turbo-compound system with a retarder, and is also used in a turbo compound retarder system (TCR system). In accordance with one embodiment the invention relates to such a TCR system.

A turbo compound system (TC system) is used in the drive train, in particular of a motor vehicle, in order to use at least a part of the exhaust gas energy of an internal combustion engine for driving of the crankshaft, which is driven by the internal combustion engine. For this purpose the turbine wheel of the exhaust gas turbine arranged on a turbine shaft, said exhaust gas turbine being connected to the exhaust gas flow of the internal combustion engine, is offset in a rotation by means of the exhaust gas flow and transfers torque or turning capacity to an input shaft of a hydrodynamic clutch. This operating state is termed as exhaust gas power turbine operation and is always present when enough power output is contained in the exhaust gas flow of the internal combustion engine.

The input shaft of the hydrodynamic clutch drives a primary wheel which with a secondary wheel forms the torus shaped working chamber of the hydrodynamic clutch. Turning capacity is transferred from the primary wheel to the secondary wheel via a hydrodynamic circuit in the working chamber filled with working fluid. This turning capacity is transferred at least indirectly to the crankshaft of the internal combustion engine.

In a turbo compound retarder system a hydrodynamic retarder is additionally provided, which in the braking operation brakes the crankshaft hydrodynamically and because of this is wear-free. For this purpose the working chamber of the retarder is filled with working fluid and transfers torque from a rotor of the retarder, which has a drive connection to the crankshaft, to the stationary stator, which exercises a braking torque on the crankshaft.

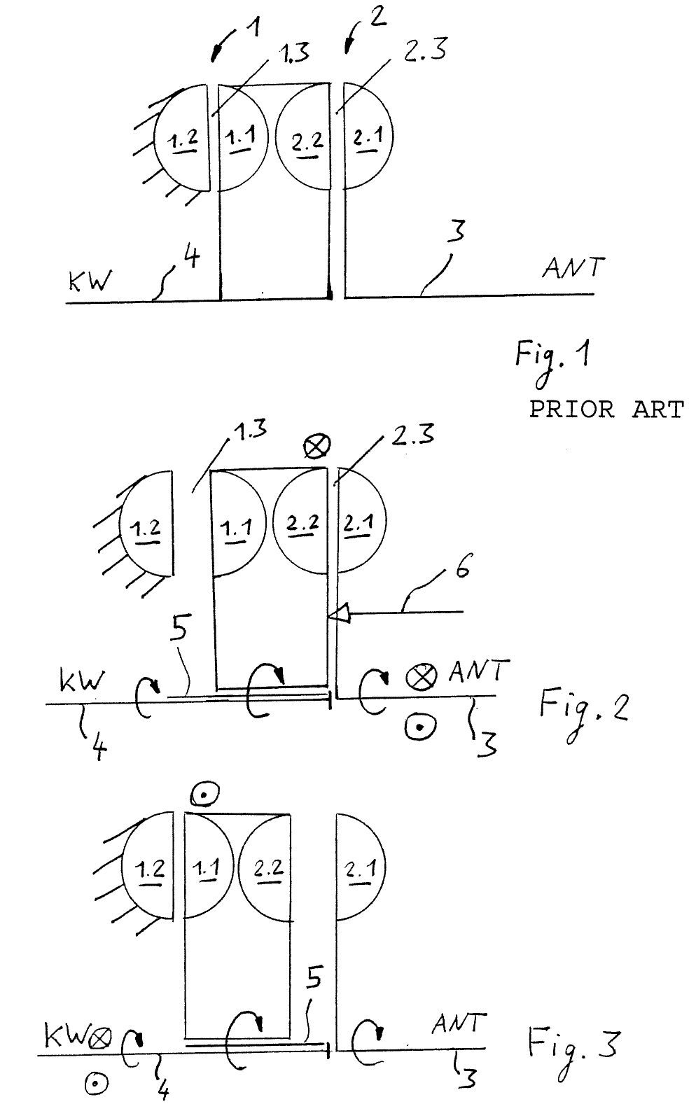

In FIG. 1 such a turbo compound retarder system in accordance with the state of the art is shown. As one sees, the rotor 1.1 of the hydrodynamic retarder 1 and the secondary wheel 2.2 of the hydrodynamic clutch 2 are arranged on a common shaft in a so-called back to back arrangement. The common shaft, termed as second input shaft 4, has a drive connection to the crankshaft (KW). In the braking operation torque is transferred via the second input shaft 4 to the rotor 1.1 and is “conducted away” via the stator 1.2.

The primary wheel 2.1 of the hydrodynamic clutch 2 is arranged opposite the secondary wheel 2.2 of the hydrodynamic clutch 2 on a first input shaft 3. The first input shaft 3 has a drive connection to the exhaust gas driven turbine (ANT) or to the turbine shaft (not shown) of the exhaust gas driven turbine (not shown). In exhaust gas power turbine operation torque is transferred via the first input shaft 3 to the primary wheel 2.1 of the hydrodynamic clutch 2. This torque or the associated turning capacity is transferred via the hydrodynamic circulation flow in the working chamber 2.3 of the hydrodynamic clutch 2 to the secondary wheel 2.2 and further via the second input shaft 4, which acts in this operating state as an output shaft, to the crankshaft.

In the braking operation exclusively the working chamber 1.3 of the hydrodynamic retarder is filled with working medium, for example oil, water or a mixture. In exhaust gas power turbine operation exclusively the working chamber 2.3 of the hydrodynamic clutch is filled with a corresponding working medium. The respective other working chamber is emptied, either completely or up to a predefined residual working medium quantity.

In the embodiment of a hydrodynamic assembly shown in FIG. 1 in accordance with the state of the art the fact is to be considered disadvantageous that also in exhaust gas power turbine operation, in which as much power as possible is to be transferred from the exhaust gas to the crankshaft, in order to lessen the fuel consumption of the internal combustion engine, the retarder generates a specific braking torque on the basis of the opposing arrangement of the rotor 1.1 and of the stator 1.2, said braking torque having the effect of a frictional loss on the drive train. Further it is to be considered disadvantageous that in the braking operation states can arise in which torque is transferred from the exhaust gas driven turbine via the hydrodynamic clutch to the rotor 1.1 of the hydrodynamic retarder 1, which lessens the braking power of the retarder 1 transferred to the crankshaft.

A turbo compound system with a hydrodynamic assembly in accordance with the generic term of Claim 1 is additionally shown in WO 02/070877 A1. Also in the case of this assembly two torus-shaped working chambers are carried out by means of a back to back arrangement, namely a first working chamber of a hydrodynamic retarder and a second working chamber of a hydrodynamic clutch.

With regard to further designs of combinations of hydrodynamic clutches and brakes reference is made to the following documents:

DE 32 29 951 A1
WO 2005/064 137 A1
DE 102 19 753 A1
DE 299 03 829 U1

The invention is based on the object of further developing a hydrodynamic assembly of the initially described type so that at least the first described disadvantage or advantageously both described disadvantages are overcome.

The inventive object is solved by means of a hydrodynamic assembly with the features of Claim 1 and as an alternative embodiment by means of a hydrodynamic assembly in accordance with Claim 7. Further Claim 10 describes an inventive turbo compound retarder system which comprises an inventive hydrodynamic assembly.

The dependent claims describe advantageous and useful embodiments of the invention.

In accordance with the first inventive embodiment the hydrodynamic assembly exhibits, corresponding to the described hydrodynamic assembly state of the art and shown in FIG. 1, a hydrodynamic retarder, a hydrodynamic clutch as well as a first input shaft and a second input shaft. The retarder exhibits a rotor and a stator which with each other form a bladed torus-shaped working chamber. Accordingly the hydrodynamic clutch exhibits a bladed primary wheel and a bladed secondary wheel which with each other also form a torus-shaped working chamber. Both working chambers can be filled with and emptied of working medium. Oil, water or a mixture, in particular a mixture of one or both of the named substances, is taken into consideration as a working medium. The rotor of the retarder and the secondary wheel of the hydrodynamic clutch are joined to each other in torsion-proof manner, in axial direction in series and in a back to back arrangement.

In accordance with the invention and in deviation to the hydrodynamic assembly represented in FIG. 1, however, the rotor of the retarder and the secondary wheel of the hydrodynamic clutch can be moved jointly in the axial direction of the hydrodynamic assembly, that is, in the direction of the axis of rotation of rotor and the blade wheels of the hydrodynamic clutch. In the process the rotor and the secondary wheel can be moved between a first position, in which the secondary wheel is opposite the primary wheel of the hydrodynamic clutch at a minimum axial distance and the rotor is opposite the stator of the hydrodynamic retarder at a maximum axial distance, and a second position, in which the secondary wheel is opposite the primary wheel of the hydrodynamic clutch at a maximum distance and the rotor is opposite the stator of the hydrodynamic retarder at a minimum axial distance. In the process minimum axial distance means that the corresponding two blade wheels forming the working chamber are so close that the desired hydrodynamic circulation flow is generated in the working chamber. Maximum distance means that the two corresponding blade wheels are arranged at such a distance from each other that no or only a defined slight maximum power is transferred from one blade wheel to the other blade wheel.

In accordance with the second inventive embodiment the hydrodynamic assembly exhibits a stator of the retarder which can be moved in axial direction in place of the rotor of the retarder and secondary wheel of the clutch which can be jointly moved. The rotor and the secondary wheel are in the process held stationary in axial direction so that the primary wheel and secondary wheel of the hydrodynamic clutch are “near” one another in any operating state or arranged at a predefined distance from one another, in which in the case of the filled working chamber of the hydrodynamic clutch a circulation flow forms for torque transfer in the working chamber.

In accordance with the second inventive embodiment the stator of the retarder can be moved from a first position, in which the stator is arranged at a distance from the rotor or at a maximum axial distance from the rotor, to a second position, in which the stator is near the rotor of the retarder, that is, is arranged at a minimum axial distance opposite the rotor so that in the case of the filled working chamber of the retarder a hydrodynamic circulatory disturbance forms for transfer of braking torque.

In accordance with both embodiments a control device is advantageously provided which controls the filling and emptying of the two working chambers with working medium. The control device is in particular designed in such a way that precisely one working chamber is always filled with working medium while the other working chamber is completely or extensively, that is up to a predefined residual working medium quantity, emptied. In the process the working chamber of the hydrodynamic clutch is filled in exhaust gas power turbine operation, and in braking operation the working chamber of the hydrodynamic retarder is filled. As an alternative the control device can also control a filling and emptying of the retarder, wherein the working chamber of the hydrodynamic clutch always remains filled, in particular by means of control through the control device. Always filled also means a varying filling degree of the working chamber; that means operating states in which the working chamber of the hydrodynamic clutch is more or less filled.

The filling or emptying of the working chambers takes place in the process advantageously in dependence on the power ratio between the two input shafts of the hydrodynamic assembly. In exhaust gas power turbine operation, in which the drive power from the exhaust gas driven turbine applied on the first input shaft is greater than the drive power of the second input shaft, which is connected to the crankshaft, a power transfer should take place from the drive power turbine to the crankshaft. Correspondingly in this operating state the working chamber of the hydrodynamic clutch is filled with working medium and the primary wheel and the secondary wheel of the hydrodynamic clutch are opposite one another at a minimum axial distance. In braking operation, on the other hand, a comparably small or no drive power of the exhaust gas turbine is applied on the first input shaft, while the second input shaft continues to be driven by the crankshaft with an in comparison greater drive power. Correspondingly the rotor and the stator of the retarder are offset at a minimum axial distance to one another and the working chamber of the retarder is filled with working medium so that torque is conducted away from the crankshaft in the form of braking torque.

In accordance with the first embodiment of the inventive hydrodynamic assembly the rotor of the retarder and the secondary wheel of the clutch are advantageously rotationally borne jointly on the second input shaft, in particular by means of a hollow shaft provided with threading on the inside, limited to the second input shaft in a threaded engagement. For example the second input shaft can exhibit an external thread which is in engagement with the internal thread of the rotor and the secondary wheel. By means of this threaded engagement the rotor and the secondary wheel are arranged rotationally displaceable between the first axial position and the second axial position on the second input shaft. The direction of the thread, which can either be constructed as a right-handed thread or as a left-handed thread, is advantageously selected in such a way that the axial position of rotor and secondary wheel is automatically set in dependence on the power ratio to the first input shaft and the second input shaft or in dependence on the turning capacity ratio between the first input shaft and the second input shaft. Provided a greater turning capacity is applied on the first input shaft, which is near the exhaust gas driven turbine or has a drive connection to the exhaust gas driven turbine, than is applied on the second input shaft, which is near the crankshaft or has a drive connection to the crankshaft, the rotor and the secondary wheel travel to the first position, in which the secondary wheel is near to the primary wheel of the hydrodynamic clutch. Provided there is a greater turning capacity on the second input shaft than is on the first input shaft, the rotor and the secondary wheel travel to the second axial position, in which the rotor is near the stator. This can be achieved by means of the fact that considered from the primary wheel of the clutch in the direction of the stator of the retarder the thread is constructed screwing inward opposite to the drive utilization of the input shafts.

In accordance with a further development of the first inventive embodiment a regulating device is additionally provided, by means of which the secondary wheel of the hydrodynamic clutch and with it simultaneously the rotor of the retarder can be forced into a remote position opposite the primary wheel of the hydrodynamic clutch, and to be precise, also when a comparatively large turning capacity or a turning capacity exceeding a predefined limiting value is present on the first input shaft, said turning capacity in particular being able to be larger than the turning capacity on the second input shaft. Such a forced removal of the secondary wheel from the primary wheel predefined from the outside, for example by inputting a regulating command into the regulating device is favorable when operating states are present in braking operation in which “normally”, that is in the case of arrangement of the primary wheel and the secondary wheel at a minimum axial distance to each other, drive power would be transferred from the exhaust gas power turbine to the crankshaft, which is undesirable. By means of purposeful removal of the secondary wheel of the hydrodynamic clutch from the primary wheel in such operating states such a power transfer from the exhaust gas power turbine to the crankshaft is prevented.

The invention will be explained more closely with the help of exemplary embodiments and FIGS. 2 through 5.

The figures show the following:

FIG. 1 shows a hydrodynamic assembly with retarder and hydrodynamic clutch in accordance with the state of the art;

FIG. 2 shows an exemplary embodiment of a first alternative of the inventive hydrodynamic assembly in exhaust gas driven turbine operation;

FIG. 3 shows the exemplary embodiment of the first alternative of the inventive assembly from FIG. 2 in braking operation;

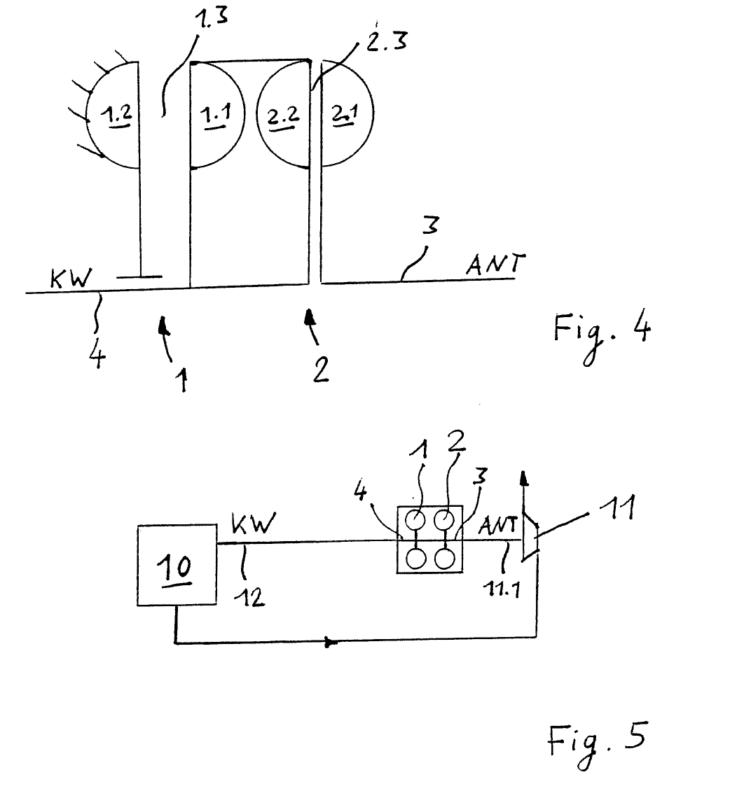

FIG. 4 shows an exemplary embodiment of the second alternative of the inventive hydrodynamic assembly;

FIG. 5 shows a schematic representation of an inventive turbo compound retarder system.

In the figures corresponding components are provided with the same reference symbols. In this respect another description of the components already described in FIG. 1 with regard to the state of the art can be dispensed with.

As one recognizes in FIGS. 2 and 3, the rotor 1.1 of the retarder 1 and the secondary wheel 2.2 of the hydrodynamic clutch 2 are borne jointly on the second input shaft 4, and to be precise, by means of a thread 5. Hence the middle component of the hydrodynamic assembly, comprising the blade wheel of the rotor 1.1 and the bladed secondary wheel 2.2 and which is enclosed in sandwich-type manner between the blade wheel of the stator 1.2 and the bladed primary wheel 2.1 of the hydrodynamic clutch 2, is axially displaceable between the first position shown in FIG. 2 and the second position shown in FIG. 3. The axial displacement motion is in the process a rotational displacement on the thread 5, which in the shown embodiment, considered from right to left, is constructed as screwing in opposite the direction of rotation of the shafts 3 and 4, that is, as a left-handed thread.

In the first position of the rotor 1.1 and of the secondary wheel 2.2 shown in FIG. 2 the secondary wheel 2.2 exhibits a minimum axial distance to the primary wheel 2.1 of the hydrodynamic clutch 2. The working chamber 2.3 of the hydrodynamic clutch 2 is filled with working medium and a circulation flow, by means of which torque from the primary wheel 2.1 is transferred to the secondary wheel 2.2, is depicted in the working chamber 2.3. By means of the arrows in FIGS. 2 and 3 the direction of rotation of the first input shaft 3, of the second input shaft 4 as well as of the middle component, which comprises the rotor 1.1 and the secondary wheel 2.2, is shown. In addition the direction of the applied turning capacity on the individual components is shown, and to be precise, in the form of circles with either a cross inside, which indicates that the direction of the turning capacity at this side runs into the sheet plane, or with a dot, which indicates that the direction of the turning capacity on this side runs out of the sheet plane. In FIG. 2, for example, the direction of the turning capacity applied on the first input shaft 3 corresponds to the direction of rotation of the input shaft 3. This turning capacity or the associated torque is transferred by means of the working medium circulation in the working chamber 2.3 to the secondary wheel 2.2, so that the turning capacity applied on the middle component also runs in the direction of the direction of rotation of the middle component. Correspondingly power is transferred from the first input shaft 3 to the second input shaft 4, which functions in this shown operating state of the exhaust gas power turbine operation as an output shaft.

In FIG. 3 on the other hand, while it is true that the direction of rotation of the second input shaft 4 (and of the middle component as well as of the first input shaft 3) is the same as in FIG. 2, and also the direction of the drive power transferred from the crankshaft, or the turning capacity applied on the second input shaft 4, corresponds to the direction of rotation of the input shafts 3 and 4; however the direction of the turning capacity which is applied on rotor 1.1 and with it on the secondary wheel 2.2, is directed opposite the direction of rotation of these two components. This is achieved by a corresponding design of the bladings of the rotor 1.1 and of the stator 1.2 of the retarder 1.

On the basis of the fact that the thread 5 in the design shown in FIGS. 2 and 3 is designed as a left-handed thread, the rotor 1.1 and the secondary wheel 2.2 in the exhaust gas power turbine operation automatically shift to the first position, that is to the right position shown in FIG. 2 on the second input shaft 4, and in the braking operation they shift to the second position, that is to the left position on the second input shaft 4, which is shown in FIG. 3.

Additionally, a servomotor (not shown) can be provided, which in the exhaust gas power turbine operation in spite of the power ratios which arise in accordance with FIG. 2, purposefully remove the secondary wheel 2.2 from the primary wheel 2.1, in order to prevent a power transfer from the primary wheel 2.1 to the secondary wheel 2.2. The compression direction of such a purposeful removal is indicated in FIG. 2 by the arrow 6.

In FIG. 4 a design of the second alternative of the inventive hydrodynamic assembly is shown. In accordance with this design the middle part, which is enclosed in sandwich-type manner between the stator 1.2 and the primary wheel 2.1 and comprises the rotor 1.1 and the secondary wheel 2.2, is held stationary in axial direction, and to be precise in a position in which the secondary wheel 2.2 is arranged at a predefined minimum axial distance to the primary wheel 2.1. This axial distance is selected in such a way that in exhaust gas power turbine operation in the case of a filled working chamber 2.3 of the hydrodynamic clutch 2 a working medium circulation to the torque transfer from the primary wheel 2.1 to the secondary wheel 2.2 ensues.

In order to lessen the frictional loss in the retarder 1, the stator 1.2 of the retarder can be axially removed from the rotor 1.1, that is, can be transported to a predefined maximum axial distance.

Of course it would also be possible to design the rotor 1.1 to be axially movable in such a way that it would be removable from the stator 1.2 in the exhaust gas power turbine operation without the axial position of the secondary wheel 2.2 simultaneously being changed. On the basis of the advantageous effect by means of a simultaneous removal of the secondary wheel 2.2 from the primary wheel 2.1 in the case of movement of the rotor 1.1 to the to the axially near position on the stator 1.2, however; the design shown in FIGS. 2 and 3 is to be preferred.

In FIG. 5 a turbo compound retarder system is schematically represented. The reference symbol 10 designates an internal combustion engine whose crankshaft 12 simultaneously represents the second input shaft 4 of the inventively designed hydrodynamic assembly with the retarder 1 and the hydrodynamic clutch 2. The first input shaft 3 of the hydrodynamic assembly is at the same time the turbine shaft 11.1 of the exhaust gas drive turbine 11, which is arranged in the exhaust gas flow of the internal combustion engine 10.

1. Hydrodynamic assembly,
with a hydrodynamic retarder comprising a rotor and a stator;
with a hydrodynamic clutch, comprising a primary wheel and a secondary wheel;
the rotor and the stator of the retarder as well as the primary wheel and the secondary wheel of the clutch respectively form with each other a torus-shaped working chamber;
the rotor of the retarder and the secondary wheel of the clutch are joined to each other in torsion-proof manner, in axial direction in series in a back to back arrangement;
the primary wheel has a drive connection to a first input shaft;
the rotor and the secondary wheel have a drive connection to a second input shaft;
characterized in that
the rotor and the secondary wheel can be moved jointly in axial direction between a first position, in which the secondary wheel is opposite the primary wheel at a minimum axial distance and the rotor is opposite the stator at a maximum axial distance, and a second position, in which the secondary wheel is opposite the primary wheel at a maximum distance and the rotor is opposite the stator at a minimum axial distance.

2. The hydrodynamic assembly according to claim 1, characterized in that the rotor and the secondary wheel are borne jointly by means of a thread on the second input shaft and can be displaced in limited manner between said input shaft between the first and second position.

3. The hydrodynamic assembly according to claim 1, characterized in that a control device is provided which alternately fills and empties the two working chambers with working medium, in particular in such a way that precisely one working chamber is always filled with working medium while the other working chamber is completely or extensively emptied, or which fills and empties working chamber of the retarder and always keeps the working chamber of the hydrodynamic clutch filled.

4. The hydrodynamic assembly according to claim 2, characterized in that the thread in its direction of rotation is designed so that in the case of a power surplus of the drive power which is applied on the first input shaft, compared to the drive power which is applied on the second input shaft, the rotor and the secondary wheel are moved to the first position, and in the case of a power surplus of the drive power which is applied on the second input shaft, compared to the drive power which is applied on the first input shaft, the rotor and the secondary wheel are moved to the second position.

5. The hydrodynamic assembly according to claim 3, characterized in that the control device is designed in such a way that in the case of a power surplus of the drive power which is applied on the first input shaft, compared to the drive power which is applied on the second input shaft, the control device fills the working chamber of the hydrodynamic clutch, and in the case of a power surplus of the drive power which is applied on the second input shaft, compared to the drive power which is applied on the first input shaft % the control device fills the working chamber of the hydrodynamic retarder.

6. The hydrodynamic assembly according to claim 1, characterized in that a regulating device is provided which, in compliance with an input regulating command, moves the rotor and the secondary wheel from the first position to the second position or in the direction of the second position, in particular to a middle position between the first position and the second position.

7. Hydrodynamic assembly,
with a hydrodynamic retarder comprising a rotor and a stator;
with a hydrodynamic clutch, comprising a primary wheel and a secondary wheel;
the rotor and the stator of the retarder as well as the primary wheel and the secondary wheel of the clutch respectively form with each other a torus-shaped working chamber;
the rotor of the retarder and the secondary wheel of the clutch are joined to each other in torsion-proof manner, in axial direction in series in a back to back arrangement;
the primary wheel has a drive connection to a first input shaft;
the rotor and the secondary wheel have a drive connection to a second input shaft;
characterized in that
the stator of the retarder can be moved between a first position, in which the stator is opposite the rotor at a maximum axial distance, and a second position, in which the stator is opposite the rotor at a minimum axial distance.

8. The hydrodynamic assembly according to claim 7, characterized in that a control device is provided which alternately fills and empties the two working chambers with working medium, in particular in such a way that precisely one working chamber is always filled with working medium while the other working chamber is completely or extensively emptied, or which fills and empties working chamber of the retarder and always keeps the working chamber of the hydrodynamic clutch filled.

9. The hydrodynamic assembly according to claim 7, characterized in that the control device is designed in such a way that in the case of a power surplus of the drive power which is applied on the first input shaft, compared to the drive power which is applied on the second input shaft, the control device fills the working chamber of the hydrodynamic clutch, and in the case of a power surplus of the drive power which is applied on the second input shaft, compared to the drive power which is applied on the first input shaft, the control device fills the working chamber of the hydrodynamic retarder.

10. Turbo compound retarder system,
with an internal combustion engine in whose exhaust gas flow an exhaust gas power turbine is connected to a turbine shaft;
with a crankshaft which is driven by the internal combustion engine;
characterized in that
a hydrodynamic assembly according to claim 1 is provided wherein the turbine shaft has a drive connection to the first input shaft or is designed integrally with said input shaft and the crankshaft has a drive connection to the second input shaft or is designed integrally with said input shaft.

11. The hydrodynamic assembly according to claim 2, characterized in that a control device is provided which alternately fills and empties the two working chambers with working medium, in particular in such a way that precisely one working chamber is always filled with working medium while the other working chamber is completely or extensively emptied, or which fills and empties working chamber of the retarder and always keeps the working chamber of the hydrodynamic clutch filled.

12. The hydrodynamic assembly according to claim 3, characterized in that the thread in its direction of rotation is designed so that in the case of a power surplus of the drive power which is applied on the first input shaft, compared to the drive power which is applied on the second input shaft, the rotor and the secondary wheel are moved to the first position, and in the case of a power surplus of the drive power which is applied on the second input shaft, compared to the drive power which is applied on the first input shaft, the rotor and the secondary wheel are moved to the second position.

13. The hydrodynamic assembly according to claim 4, characterized in that the control device is designed in such a way that in the case of a power surplus of the drive power which is applied on the first input shaft, compared to the drive power which is applied on the second input shaft, the control device fills the working chamber of the hydrodynamic clutch, and in the case of a power surplus of the drive power which is applied on the second input shaft, compared to the drive power which is applied on the first input shaft, the control device fills the working chamber of the hydrodynamic retarder.

14. The hydrodynamic assembly according to claim 2, characterized in that a regulating device is provided which, in compliance with an input regulating command, moves the rotor and the secondary wheel from the first position to the second position or in the direction of the second position, in particular to a middle position between the first position and the second position.

15. The hydrodynamic assembly according to claim 3, characterized in that a regulating device is provided which, in compliance with an input regulating command, moves the rotor and the secondary wheel from the first position to the second position or in the direction of the second position, in particular to a middle position between the first position and the second position.

16. The hydrodynamic assembly according to claim 4, characterized in that a regulating device is provided which, in compliance with an input regulating command, moves the rotor and the secondary wheel from the first position to the second position or in the direction of the second position, in particular to a middle position between the first position and the second position.

17. The hydrodynamic assembly according to claim 5, characterized in that a regulating device is provided which, in compliance with an input regulating command, moves the rotor and the secondary wheel from the first position to the second position or in the direction of the second position, in particular to a middle position between the first position and the second position.

18. The hydrodynamic assembly according to claim 8, characterized in that the control device is designed in such a way that in the case of a power surplus of the drive power which is applied on the first input shaft, compared to the drive power which is applied on the second input shaft, the control device fills the working chamber of the hydrodynamic clutch, and in the case of a power surplus of the drive power which is applied oil the second input shaft, compared to the drive power which is applied on the first input shaft, the control device fills the working chamber of the hydrodynamic retarder.

19. Turbo compound retarder system,
with an internal combustion engine in whose exhaust gas flow an exhaust gas power turbine is connected to a turbine shaft;
with a crankshaft which is driven by the internal combustion engine;
characterized in that
a hydrodynamic assembly according to claim 2 is provided wherein the turbine shaft has a drive connection to the first input shaft or is designed integrally with said input shaft and the crankshaft has a drive connection to the second input shaft or is designed integrally with said input shaft.

20. Turbo compound retarder system,
with an internal combustion engine in whose exhaust gas flow an exhaust gas power turbine is connected to a turbine shaft;
with a crankshaft which is driven by the internal combustion engine;
characterized in that
a hydrodynamic assembly according to claim 7 is provided wherein the turbine shaft has a drive connection to the first input shaft or is designed integrally with said input shaft and the crankshaft has a drive connection to the second input shaft or is designed integrally with said input shaft.
